(19) United States
(12) Patent Application Publication
(10) Pub. No.: US 2006/0118492 A1
(43) Pub. Date: Jun. 8, 2006

(54) Integrated column, related system and method for liquid chromatography

(76) Inventors: Chia-Hui Shieh, Fremont, CA (US); Rong Zeng, Shanghai (CN)

Correspondence Address: Junrui Yang, 6815 Devon Way, San Jose, CA, 95129, US

(21) Appl. No.: 11/295,283

(22) Filed: Dec. 6, 2005

Related U.S. Application Data
(60) Provisional application No. 60/634,128, filed on Dec. 8, 2004.

(51) Int. Cl. B01D 15/08

(52) U.S. Cl. 210/656; 210/198.2; 436/161; 422/70; 356/300

(57) ABSTRACT

An integrated column for liquid chromatography is disclosed. A system comprising an integrated column and methods of using an integrated column are also described.

### CROSS REFERENCE TO RELATED APPLICATIONS

This application claims the benefits of the provisional application No. 60/634,128, filed Dec. 8, 2004, which is hereby incorporated in its entirety for all purposes.

### FIELD OF THE INVENTION

The present invention relates to liquid chromatography and particularly relates to integrated columns, systems comprising integrated columns, and methods for using integrated columns for liquid chromatography.

### BACKGROUND OF THE INVENTION

In a liquid chromatographic system or a total solution liquid chromatographic system, the liquid chromatography (LC) column is located between an injector and a detector to separate one or more constituents of interest from the various interferences in a sample to be analyzed and to permit detection of these constituents by the detector. A typical mass detector in a liquid chromatographic system can measure and provide an output in terms of mass per unit of volume or mass per unit of time of the sample's components. From such an output signal, a “chromatogram” can be provided. The chromatogram can then be used by an operator to accurately identify and quantitate the chemical components present in the sample.

A trend in chromatography has been to move to higher performance and miniature liquid chromatography columns. The reason for the strong recent trend toward miniaturization is that miniaturized liquid chromatography columns have extremely low solvent consumption and require drastically reduced volumes of sample for analysis, hence providing high efficiency, sensitive separations when samples are limited. In liquid chromatography, high resolution has been obtained using narrow diameter columns packed with microparticles. A miniature microparticle packed liquid chromatography column is typically manufactured by packing a narrow diameter tube uniformly with separation media such as bonded silica particles, also referred to as packing material or stationary phase.

Materials commonly used for the preparation of miniature analytical columns include polymer, glass, metal, fused silica and its subgroups polymer-coated fused silica and polymer-clad fused silica. Representative metals typically include stainless steel and glass-lined stainless steel.

Miniature liquid chromatography columns include small bore, microbore and capillary columns. These columns typically have lengths ranging from about 5 mm to 300 mm, but in some instances they may approach lengths of up to 5000 mm. Small bore columns generally have inner diameters of about 2 mm, whereas microbore columns have diameters of approximately 1 mm. Fused silica and other capillary columns typically have inner diameters of less than 1 mm and often less than 0.1 mm. In fact, capillary columns having inner diameters of 0.075 mm have almost become standard for liquid chromatography mass spectrometry. Fused silica capillary columns can withstand high packing pressure, e.g., 9000 psi or greater.

Silica capillary packed with reverse phase material has been used in the proteomics field for the analysis of protein/peptides by HPLC-MS/MS. The method uses a high performance liquid chromatography (HPLC) system in conjunction with mass detector. Thousands of protein/peptides were separated by HPLC and then characterized by tandem mass. Peptide sequence is identified by matching the mass/mass (MS/MS) spectra with theoretical spectra. Protein is identified by matching peptide sequence with predict fragments from genomic or proteomics data base.

Although one dimensional reverse phase (RP) HPLC followed by mass analysis is a powerful tool for the protein/peptide analysis, it is inherently limited by the number of peptides that can successfully be loaded and resolved on a single column and detected by the mass spectrometer. In a complex sample, there may be thousands of proteins. To increase the resolving power of capillary of the HPLC separation, two dimensional HPLC techniques are employed using a combination of ion exchange chromatography where peptides are separated by their charge followed by RP HPLC where peptides are separated by their hydrophobicity.

One example is using a packed mix bad spray tips for the separation peptides by ion exchange-reverse phase separation before mass analysis. John Yates reported proteomics analysis of yeast proteome by two dimensional LC-MS/MS. The peptide mixture was loaded onto ion exchange column and eluted by different salt concentrations. The peptide fractions were separated by the reverse phase gradient and then analyzed by tandem mass spectrometry. Thousands of proteins were identified form data base by this method. The method has the advantage of two dimensional LC separation, but requires extensive wash to remove salt before reverse phase-tandem mass analysis. The packed mixed bed also is not stable and only can be used for a few injections.

Another example is where a strong cation exchange (SCX) column of analytical dimensions is used in conjunction with two reverse phase columns for resolving a protein tryptic digest. Complex samples can be pre-fractionated on the SCX column, collected and separated by reversed phase column for final resolution, detection and identification by a mass spectrometer. The two reverse phase columns also can be used to alternate loading/cleaning and separation at same time. This system is a very powerful tool for the separation of complicated protein mixtures. However, it requires two sets of HPLC pumps, two reverse phase HPLC columns, and complicated software to operate the system. The normal one dimensional HPLC system are not able to perform the same separation.

There is a need, therefore, for an HPLC method or system using one dimensional HPLC system, with no salt gradient, for the separation of protein/peptide mixture achievable now through two dimensional HPLC-MS/MS analysis.

### SUMMARY OF THE INVENTION

The present invention is directed to an integrated column for liquid chromatography which comprises a first column (or section) and a second column (or section). The two columns (or sections) have orthogonal separation modes. Orthogonal separation modes here mean two different separation mechanisms. When two columns have orthogonal separation modes, they are usually packed with two different stationary phases. For example, one of the columns can be selected from the group consisting of a cation exchange column, an anion exchange column, an affinity column and a metal chelating column; and the other column can be a reverse phase column. In another example, the two columns can be selected independently from the group consisting of a cation exchange column, an anion exchange column, an affinity column, a metal chelating column, and a reverse phase column.

The mobile phases used for the integrated column are compatible with mass spectrometer, therefore eliminating the need for extensive column washing associated with salt gradients. For example, a mobile phase with pH gradient can be used to separate protein/peptide according to their isoelectric points (pIs). This is then followed by mobile phases suitable for reverse phase separation.

According to certain embodiments of the present invention, the two columns having orthogonal separation modes can be connected through tubing and fittings; can be directly attached; or can be directly attached through nuts and fittings.

In another embodiment, the two sections of the integrated column are packed in a single column to form a mixed bed HPLC column. For example, a portion of a column is packed with strong cation exchange material and the rest of the column is packed with reverse phase material.

In yet another embodiment, the first column is a sample preparation cartridge. An example of a sample preparation cartridge is a holder with two filters at each end and stationary phase in between.

In certain embodiments, the integrated column may further comprise one or more additional columns (or sections).

The material used for the integrated column may be selected, but not limited to, fused silica, polymer-coated fused silica, polymer-clad fused silica, stainless steel, glass, glass-lined stainless steel, metal or polymer.

The columns or the sections of the integrated column may also be in the form of HPLC-chips. A HPLC-Chip is a microfluidic chip-based device that can carry out nanoflow high performance liquid chromatography (HPLC). An example of a HPLC-chip is a reusable microfluidic polymer chip, smaller than a credit card. The HPLC-chip integrates the sample enrichment and separation-columns of a nanoflow LC system with the intricate connections and spray tip used in electrospray mass spectrometry directly on the polymer chip.

In certain embodiments, the columns independently have an inner diameter between about 0.05 mm and about 10 mm, preferably between about 0.15 mm and about 4.6 mm, and more preferably between about 0.15 mm and about 1.0 mm.

In certain embodiments, the columns independently have a length between about 5 mm and about 500 mm, preferably between about 20 mm and about 300mm, and more preferably between about 100 mm and about 250 mm.

The present invention is also directed to a liquid chromatography system for analyzing mixtures comprising an injector; at least one set of HPLC pump(s); an integrated column for liquid chromatography which comprises a first column (or section) and a second column (or section) wherein the first and second columns having orthogonal separation modes; one or more mobile phases; and a detection device.

In certain embodiments, the integrated column in the system may further comprise one or more additional columns (or sections), preferably, one or up to ten, one or up to six, and more preferably one or up to two additional columns (or sections)

In certain embodiments, the system comprises a single set of HPLC pump(s). A set of HPLC pump(s) includes one or more HPLC pumps. For example, a typical one-dimension HPLC system has one set of HPLC pump(s).

In certain embodiments, the detection device is a mass spectrometer.

In certain embodiments, the one or more mobile phases are compatible with a mass spectrometer. For example, a mobile phase with pH gradient followed by mobile phase suitable for RP HPLC. pH Gradient can be a step gradient, a continuous gradient, or a combination thereof.

The present invention is further directed to methods for separating mixtures using an integrated column and/or a system comprising an integrated column. The mixtures being separated include, but not limited to, small molecules, proteins or peptides, or a combination thereof.

### BRIEF DESCRIPTION OF THE DRAWINGS

FIG. 1 shows an example of an integrated column wherein first column and second column are directly attached.

FIG. 1A is an enlarged view of a part of the integrated column showing the connection between first column and second column and the end fitting of the analytical column.

FIG. 1B is an enlarged view of one end of the integrated column.

FIG. 2 shows an example of an integrated column wherein first column and second column are connected by capillary tubing.

FIG. 3 shows an example of an integrated column wherein first section and second section are two different stationary phases packed into a single column.

FIGS. 4 and 5 show the chromatograms of the separation of mouse liver proteins by an integrated ion exchange-reverse phase column.

### DETAILED DESCRIPTION OF THE INVENTION

Most two dimensional HPLC separations to date have been carried out using strong cation exchange and reverse phase HPLC columns. The protein/peptide mixture was fractionated by strong cation exchange followed by reverse phase separation. However the conventional cation exchange separation requires salt gradient and is not compatible with mass spectrometers. Therefore an off line cation exchange separation or extensive column wash after loading is required before mass analysis. Present invention address this problem using an integrated column, and a system comprising an integrated column, and one or more mobile phases compatible with a mass spectrometer.

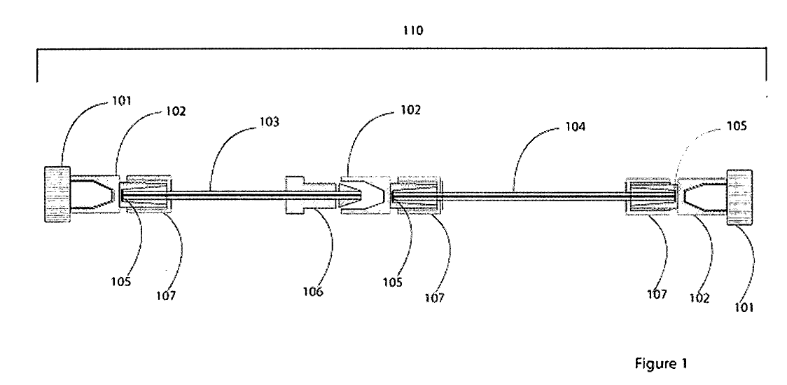

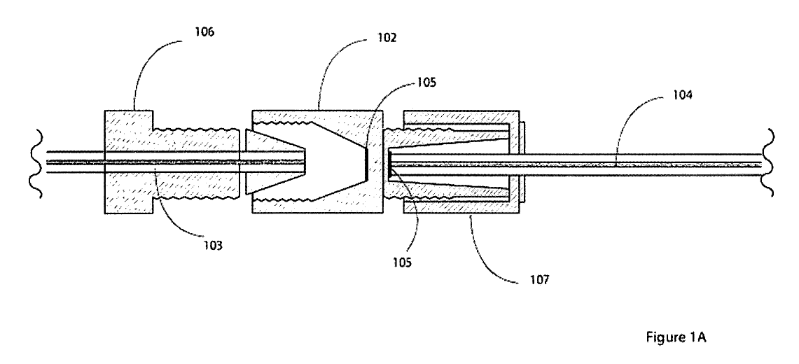

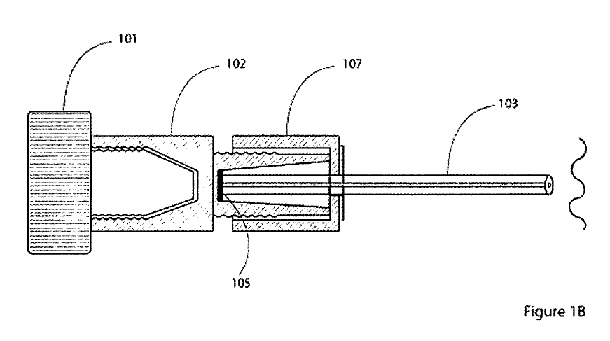

FIG. 1 illustrates an example of integrated column 110. Integrated column 110 comprises a first column 103 and a second column 104. Column 103 and 104 are connected through connecting nut 106, end fitting 102 and end fitting 107. Column 110 may also comprises end nut 101, end fitting 102, end fitting 107 and frit 105 as illustrated in FIG. 1.

When using integrated column 110 for protein/peptide separation, for example, the analyte mixture is loaded onto a strong cation exchange column at low pH. A small amount of pH buffer is then pumped through a solvent selector or injected through an injection loop. By changing the gradient of the pH buffer, the protein/peptide mixture is fractionated according to their isoelectric points (pIs). When the pH of the mobile phase is same or higher than their pIs, the proteins/peptides are not negatively charged and are eluted out from the cation exchange column. Consequently, this fraction is further separated by a reverse phase HPLC column with a mobile phase suitable for reverse phase HPLC separation. Only a small amount of pH buffer is needed for separation. No salt gradient is used. This allows direct connection of an HPLC system to a mass spectrometer without the need for extensive column wash. The pH buffers used for separation are compatible with mass spectrometer. For example, formic acid, acetic acid or citric acid can be used as acids. Ammonia or substituted amines can be used as bases. By using integrated columns and mobile phases compatible with mass spectrometer, the present invention uses one HPLC system for the separation of complex protein/peptide mixtures. Previously, this is only achievable through conventional two dimension HPLC separation with two HPLC systems.

FIG. 1A is an enlarged view of part of integrated column 110, illustrating first column 103 and second column 104 are directly attached though connecting nut 106, end fitting 102 and end fitting 107. It may also comprise frits 105.

FIG. 1B is an enlarged view of one end of integrated column 110, with end nut 101, end fitting 102 and end fitting 107.

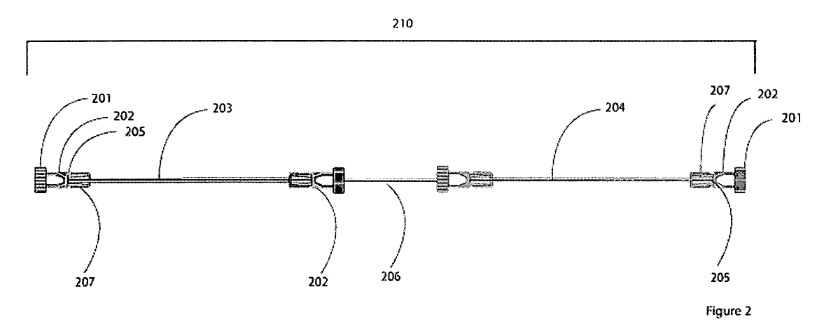

FIG. 2 illustrates another example of integrated column 210. In this example, first column 203 and second column 204 are connected through capillary tubing 206. Column 210 may also comprise end nut 201, end fitting 202, end fitting 207, and frit 205.

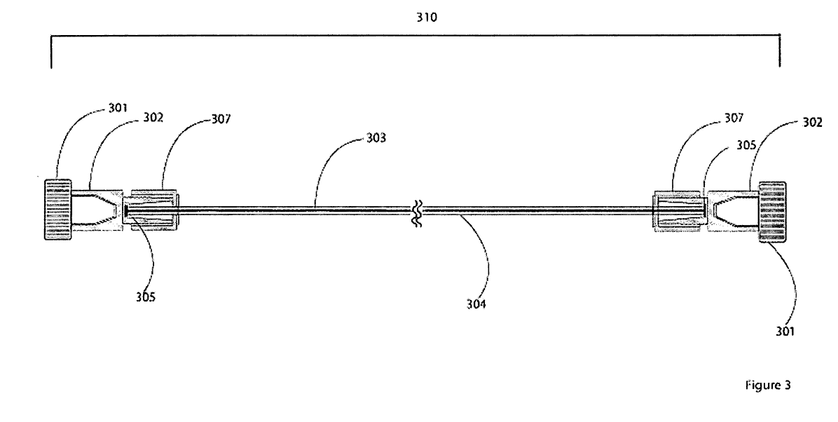

FIG. 3 illustrates yet another example of integrated column 310. Column 310 is a mixed bed HPLC column. In this example, first column is first section 303 and second column is second section 304. Section 303 and section 304 are two different stationary phases packed in a single column. For example, a portion of column 310, section 303, is packed with strong cation exchange material, and rest of the column, section 304, is packed with reverse phase material. Column 310 may also comprise end nut 301, end fitting 302, end fitting 307 and frit 305. A frit or filter (not shown in FIG. 3) may be included in between section 303 and section 304.

While FIGS. 1, 2 and 3 illustrate some examples of the present invention, it is obvious to person skill in the art that numerous modifications can be made without departing from the scope of the invention. For example, section 303 and section 304 can be packed into an electro-spray interface tip (ESI tip). The columns and sections of the integrated column can be in the form of HPLC-chips.

The following example illustrates one of numerous applications using an integrated column.

### EXAMPLE

Material

Water used in the experiment was prepared using a Milli-Q system (Millipore, Bedford, Mass., USA). Urea, dithiothreitol (DTT), ammonium bicarbonate and iodoacetamide (IAA) were purchased from Bio-Rad (Hercules, Calif., USA). Guanidine hydrochloride and citric acid were obtained from Sigma (St. Louis, Mo., USA). Trypsin was purchased from Promega (Madison, Wis., USA). Formic acid (FA), trifluoroacetic acid and acetonitrile were obtained from Aldrich (Milwaukee, Wis., USA). Trimethylamine was purchased from Applied Biosystems (Foster City, Calif., USA). Ammonium hydroxide was obtained from Shanghai Chemical Plant (Shanghai, China). All the chemicals were of analytical grade except acetonitrile, which was of HPLC grade.

Methods

I. Sample Preparation

Total Liver Sample:

Mouse liver tissue (1.0 g) was suspended in 10 ml of lysis buffer consisting of 8M urea, 4% 3-[(3-Cholamidopropyl)dimethylammonio]-1-propanesulfonate (CHAPS), 65 mM dithiothreitol (DTT), 40 mM 2-Amino-2-(hydroxymethyl)-1,3-propanediol(Tris). The suspension was homogenized for approximately 1 min, sonicated for 100 w×30 s and centrifuged at 25,000 g (RCF) for 1 hour.

The supernatant contained the total liver proteins. Protein contents were estimated with a Bradford protein assay using bovine serum albumin (BSA) as a protein standard.

II. Trypsin Digestion

Protein sample (600 μg) was filtered and redissolved in reducing solution (6 M guanidine hydrochloride, 100 mM ammonium bicarbonate, pH 8.3). Then the protein sample in 100 μL of reducing solution was mixed with 2 μL of 1 M dithiothreitol. The mixture was incubated at 56° C. for 1 hour. After the addition of 10 μL of 1 M iodoacetamide, the mixture was incubated for an additional 40 minutes at room temperature in darkness. The protein mixture was spun and exchanged into 100 mM ammonium bicarbonate buffer, and then incubated with trypsin (50:1) at 37° C. for 20 hours.

III. 2D LC-MS/MS Shotgun Analysis

The 2D LC-MS/MS experiments were performed using a LCQ Deca XP Plus ion trap mass spectrometer (Thermo, San Jose, Calif.). A Surveyor liquid chromatography system (Thermo, San Jose, Calif.), including an auto sampler and one high-pressure pump, was equipped with an integrated column. The integrated column included two sections. The front section was SCX and the back RP. The liquid chromatography solvents used for SCX were a series of pH solutions (pH 2.5, pH 3, pH 3.5, pH 4, pH 4.5, pH 5, pH 5.5, pH 6, pH 7, and pH 8). The pH 2 solution was an aqueous acid (formic acid, citric acid and the like), and the pH 8 solution was an aqueous base (Ammonium hydroxide, trimethylamine and the like). A base was used to adjust the pH of acidic solution from pH 3 to pH 7. The liquid chromatography solvents used for RP gradient were, for example, mobile phase A: 0.1% formic acid in water (v/v); and mobile phase B: 0.1% formic acid in acetonitrile (v/v).

The tryptic digested peptide mixture was injected to the top of the integrated column using Surveyor auto sampler (AS) no-waste function. A pH 2.5 solution was applied to the integrated-column by LC pump, or auto sampler using full loop injection function. The integrated column was then washed with mobile phase A for a time period (for example, 80 min). It was then followed by RP gradient, for example, 5 to 65% mobile phase B for 115 minutes.

The procedure was repeated using a series of pH solutions in place of pH 2.5 solution. For example, pH 3, pH 3.5, pH 4, pH 4.5, pH 5, pH 5.5, pH 6, pH 7, and pH 8.

The eluted peptides were analyzed by MS equipped with an Orthogonal Electron spray ion source. The temperature of heated capillary was set at 200° C. A voltage of 3.3 kV applied to the ESI needle resulted in a distinct signal. Normalized collision energy was 35.0. The number of ions stored in the ion trap was regulated by the automatic gain control. The mass spectrometer was set that one full MS scan was followed by three MS/MS scans on the three most intense ions from the MS spectrum with the following Dynamic Exclusion™ settings: repeat count 3, repeat duration 0.8 min, exclusion duration 3.0 min.

IV. Protein Identification

The acquired MS/MS spectra were automatically searched against protein database for human proteins (EMBL-EBI proteome set for Homo sapiens (Human), released Jun. 4, 2004) using the TurboSEQUEST program in the BioWorks™ 3.0 software suite. An accepted SEQUEST result had to have a ΔCn score of at least 0.1 (regardless of charge state). Peptides with a +1 charge state were accepted if they were fully tryptic and had a cross correlation (Xcorr) of at least 1.9. Peptides with a +2 charge state were accepted if they had an Xcorr >2.2. Peptides with a +3 charge state were accepted if they had an Xcorr >3.75.

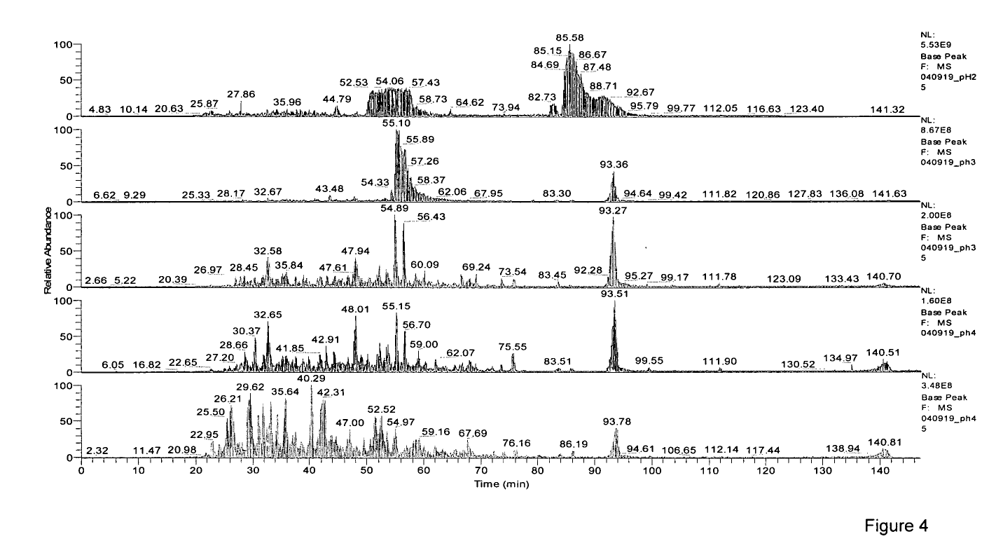

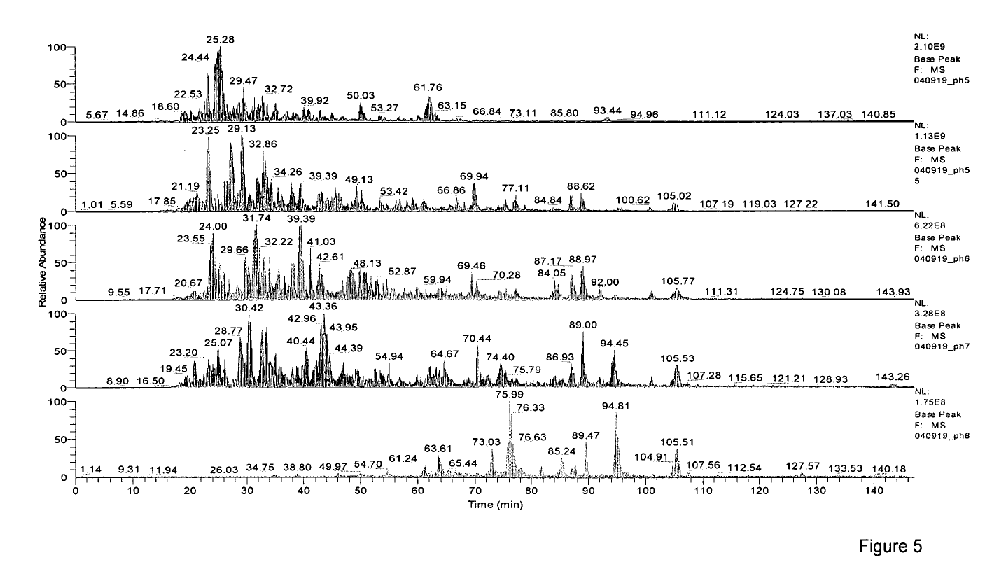

FIGS. 4 and 5 show the chromatograms for the separation of peptide mixtures by two dimensional LC-MS/MS using an integrated column. Peptides from tryptic digest of mouse liver proteins was first loaded on the top of strong cation exchange column and then eluted into reverse phase column by the injection of pH buffer plugs. When each of buffer plugs passed through ion exchange column, a fraction of peptides were eluted to the top of reverse phase column. The peptides were then separated by reverse phase gradient and analyzed by the tandem mass spectrometry. The MS/MS spectra were used for the data base search and proteins were identified by the Bioworks 3.0 software. The results are summarized in Table 1. Total of 1105 proteins from mouse liver were identified by this method.

TABLE 1

| | pH | | | | | | | | | | |
|---|---|---|---|---|---|---|---|---|---|---|---|
| | 2.5 | 3.0 | 3.5 | 4.0 | 4.5 | 5.0 | 5.5 | 6.0 | 6.6 | 8.0 | Total |
| Number of | 177 | 264 | 369 | 386 | 333 | 364 | 471 | 484 | 397 | 296 | 1105 |
| Proteins | | | | | | | | | | | |

The present invention has been described with a certain degree of particularity. It is understood to those skilled in the art that the present disclosure of embodiments has been made by way of examples only and that numerous changes in the arrangement and combination of parts may be resorted without departing from the spirit and scope of the invention. While the embodiments discussed herein may appear to include some limitations as to the presentation of the information units, in terms of the format and arrangement, the invention has applicability well beyond such embodiments, which can be appreciated by those skilled in the art.

What is claimed is:

1. An integrated column for liquid chromatography comprising a first column and a second column wherein said first column and said second column having orthogonal separation modes.

2. The integrated column of claim 1, wherein said first column is selected from the group consisting of a cation exchange column, an anion exchange column, an affinity column and a metal chelating column; and said second column is a reverse phase column.

3. The integrated column of claim 1, wherein said first column is a reverse phase column; and said second column is selected from the group consisting of a cation exchange column, an anion exchange column, an affinity column and a metal chelating column.

4. The integrated column of claim 1, wherein said first column and said second column are connected through tubing and fittings.

5. The integrated column of claim 1, wherein said first column and said second column are directly attached.

6. The integrated column of claim 5, wherein said first column and said second column are directly attached through nuts and fittings.

7. The integrated column of claim 1, wherein said first column is a first section of the integrated column, said second column is a second section of the integrated column, and said first section and said second section are packed in a single column.

8. The integrated column of claim 1, wherein said first column is a sample preparation cartridge.

9. The integrated column of claim 1, which further comprises one or more additional columns.

10. The integrated column of claim 1, wherein said first column and said second column independently comprise a material selected from the group consisting of fused silica, polymer-coated fused silica, polymer-clad fused silica, stainless steel, glass, glass-lined stainless steel, metal and polymer.

11. The integrated column of claim 1, wherein said first column and said second column are HPLC-chips.

12. The integrated column of claim 1, wherein said first column and said second column independently have an inner diameter between about 0.05 mm and about 10 mm.

13. The integrated column of claim 12, wherein said first column and said second column independently have an inner diameter between about 0.15 mm and about 4.6 mm.

14. The integrated column of claim 13, wherein said first column and said second column independently have an inner diameter between about 0.15 mm and about 1.0 mm.

15. The integrated column of claim 1, wherein said first column and said second column independently have a length between about 5 mm and about 500 mm.

16. The integrated column of claim 15, wherein said first column and said second column independently have a length between about 20 mm and about 300 mm.

17. The integrated column of claim 16, wherein said first column and said second column independently have a length between about 50 mm and about 250 mm.

18. The integrated column of claim 1, wherein one of said orthogonal separation modes comprising a mobile phase with pH gradient.

19. A system for mixtures analysis comprising
an injector;
at least one set of HPLC pump(s);
an integrated column for liquid chromatography comprising a first column and a second column wherein said first column and said second column having orthogonal separation modes;
one or more mobile phases; and
a detection device.

20. The system of claim 19, wherein said integrated column further comprises one or more additional columns.

21. The system of claim 19, wherein said at least one set of HPLC pump(s) consisting of a single set of HPLC pump(s).

22. The system of claim 19, wherein said detection device is a mass spectrometer.

23. The system of claim 19, wherein said one or more mobile phases are compatible with a mass spectrometer.

24. The system of claim 23, wherein at least one of the said one or more mobile phases is a mobile phase with pH gradient.

25. A method for separating mixtures using the integrated column of claim 1.

26. The method of claim 25 wherein said mixtures are proteins, peptides, small molecules or a combination thereof.

27. A method for separating mixtures using the system of claim 19.

28. The method of claim 27, wherein said mixtures are proteins, peptides, small molecules or a combination thereof.
